(19) United States
(12) Patent Application Publication
(10) Pub. No.: US 2006/0058027 A1
(43) Pub. Date: Mar. 16, 2006

(54) Method and apparatus for carrier frequency estimation and correction for GPS

(75) Inventors: Jing Fang, Austin, TX (US); Satish Shankar Kulkarni, Austin, TX (US)

Correspondence Address: MOTOROLA INC, 600 NORTH US HIGHWAY 45, ROOM AS437, LIBERTYVILLE, IL, 60048-5343, US

(73) Assignee: MOTOROLA, INC., Schaumburg, IL (US)

(21) Appl. No.: 10/940,365

(22) Filed: Sep. 14, 2004

(51) Int. Cl. H04B 1/00; H04B 17/00; H04Q 7/20

(52) U.S. Cl. 455/434; 455/63.1; 455/67.11

(57) ABSTRACT

A method and apparatus for frequency estimation useful in location determination utilizes a plurality of energy detectors to estimate the frequency associated with a peak energy value as determined by the energy detectors. An iterative process is implemented such that the frequency estimate corresponds to the Doppler frequency or carrier frequency error.

### TECHNICAL FIELD

This patent relates to carrier frequency estimation and correction and more particularly to a method and apparatus providing Doppler frequency estimation or carrier frequency error and use of such methods and apparatus in systems and devices.

### BACKGROUND

The global positioning system or GPS, as it is most commonly known, uses a network of orbiting space vehicles (SVs), each of which transmit two common carriers. Unique to each SV, the common carriers are modulated by spread spectrum codes with unique pseudo random noise (PRN) sequences associated with the SV and a navigation data message. A GPS receiver tracks the SV signals and estimates time-of-arrival (TOA) ranging to determine user position from the PRN sequence for the desired SV and the carrier signal, including Doppler effects. Relative movement of the transmitter and receiver results in the carrier frequency of the received signal being different than that of the transmitted signal, i.e., Doppler frequency or carrier frequency error. More accurate Doppler frequency estimation allows more accurate TOA estimates and, therefore, more accurate position estimates.

Existing GPS receivers use typically one of two approaches to estimate Doppler frequency. A first approach uses fast Fourier transform (FFT). The other approach uses a trial method over a small number of specified frequencies. The resolution of frequency estimation in the FFT approach is generally low since. Using the FFT approach, the bandwidth of interest is divided into a number of discrete increments, or the FFT order. The order is limited to 2048 due to hardware complexity. The result over an approximately 2 mega-Hertz (MHz) search band is a resolution of approximately 1 kilo-Hertz (kHz), i.e., 2 MHz divided into 2048 1 kHz increments. The trial approach is simple in implementation, but also is limited, and the relatively small number of specified trial frequencies only provide course estimation.

### BRIEF DESCRIPTION OF THE DRAWINGS

FIG. 1 is a block diagram representation of a device in accordance with a described embodiment of the invention.

FIG. 2 is a block diagram depiction of the frequency estimator depicted as part of the device of FIG. 1.

FIG. 3 is a schematic illustration of a process implemented by a frequency estimator in accordance with the described embodiments.

FIG. 4 is a block diagram representation of a device in accordance with an alternate described embodiment of the invention.

### DETAILED DESCRIPTION

In accordance with the described embodiments of the invention, a frequency estimator may be deployed as a standalone device or module or as part of a device or system providing location information including position and tracking information. The frequency estimator may include a plurality of energy detectors, each having an adjustable bandwidth and center frequency. The energy detectors provide fast, efficient determination of a peak energy value. Since the correlated received space vehicle (SV) signal of a satellite based location system has its peak energy located at Doppler frequency, Doppler frequency may be estimated based upon the frequency at which the peak energy value is reported with high resolution and reduced computation.

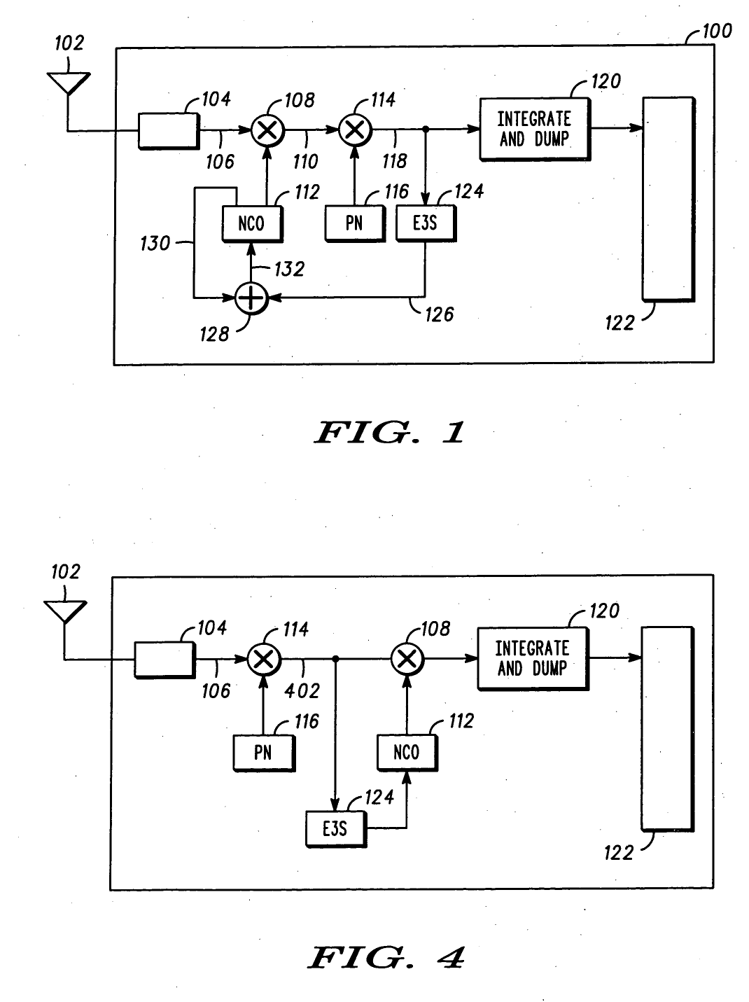

Referring to FIG. 1, the device 100 receives a SV signal at the antenna 102. A front end processor 104 processes the received SV signal, e.g., filters, down-converts, amplifies, etc., as is well known in the art, to form a received baseband signal 106. Next, a frequency correction process is performed on the baseband signal 106 within the frequency correction circuit 108 providing a frequency corrected signal 110. The frequency correction circuit 108 receives as an input, an output of a numerically controlled oscillator (NCO) 112.

The frequency corrected signal 110 is despread by despreader 114 that operates in response to a pseudo noise (PN) code provided by a pseudo noise code generator 116. The despread signal 118 is integrated/accumulated by integrator 120, the output of which is available to a processing device 122, such as a microprocessor (μP), digital signal processor (DSP), or other suitable circuit or device, to provide acquisition, tracking, measurement and other location determination related processes and functionality. The output of the processing device 122 may be provided to a display device (not depicted) or otherwise used to provide location based services to a user of the device 100. The device 100 may be a standalone device, or the device 100 may be coupled to or integrated with other devices or systems. For example, the device 100 may be a handheld navigation, location or tracking device, a personal communication device, such as a cellular telephone, a personal digital assistant (PDA), a wireless data communication device, e.g., a WiFi enable device, and the like. The device 100 may also be coupled to or integrated with a navigation system as part of a vehicle or otherwise.

A frequency detector 124 is coupled to an output of the despreader 114. It will be understood that the frequency detector 124 may be implemented as a separate module or device. Alternatively, the frequency detector 124 may be implemented as a process within the processing device 122 or otherwise in the circuitry, systems and components of the device 100.

An output 126 of the frequency detector 124 is an estimated error between Doppler frequency and the estimated frequency generated by the NCO 112. An adder 128 provides and updated control signal to the NCO 112. The NCO 112 is responsive to the control signal 132 to adjust its output such that the signal provided as an input to the correction circuit 108 is substantially the estimated Doppler frequency.

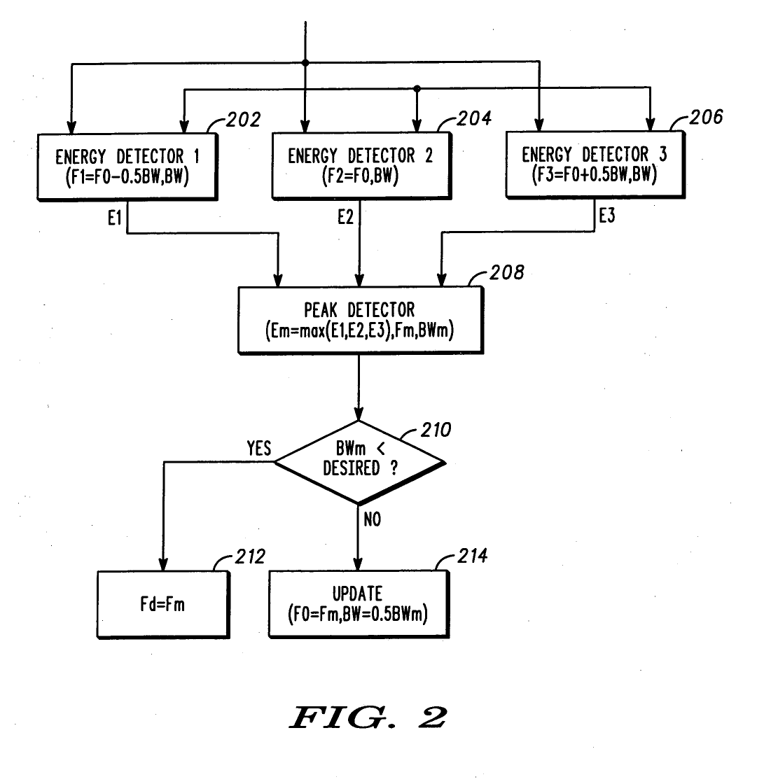

FIG. 2 depicts the frequency estimator 124, which includes a plurality of energy detectors. Three energy detectors 202, 204 and 206 are depicted, although more or fewer energy detectors may be employed. Each of the energy detectors 202, 204 and 206 is configurable to have a bandwidth, BW1, BW2 and BW3, and a center frequency, F1, F2 and F3, respectively. As shown in the example of FIG. 2, however, each of the energy detectors have the same bandwidth, BW. The center frequencies and the corresponding bandwidth values of the energy detectors define a search band sufficiently covering the expected energy distribution of the received signal, as discussed below.

In one implementation, the energy detectors 202, 204 and 206 may be a filter followed by a rectifier. For example, one low-cost low-pass filter can be a transcendental filter where filter coefficients are in the form of sine or cosine functions. Such a filter also can be designed using a Coordinate Rotation Digital Computer (CORDIC) algorithm which computes sines, cosines, and other transcendental functions with n bits of accuracy in n iterations where each iteration requires only a small number of shifts and additions with fixed-point arithmetic. In another implementation, the energy detector 202, 204, and 206 may be a quadratic detector. For example, a linear summation of lag-weighted instantaneous autocorrelation.

Updated block 214 updates the energy detector center frequency and bandwidth for the subsequent search operations. One implementation of updating energy detector center frequency is to modulate the low-pass detector With the appropriate center frequency using the CORDIC algorithm.

A peak detector 208 selects the peak energy output, Em, from the outputs E1, E2, E3, of the energy detectors 202, 204 and 206, respectively, and identifies the corresponding center frequency, Fm, and bandwidth, BWm, of the energy detector 202, 204 or 206 at which the peak or maximum output was detected. A comparison function 210 determines if the bandwidth, BWm, is less than a desired bandwidth value, i.e., if the desired level of frequency resolution is achieved. If the desired resolution is achieved, an identify function 212 equates the Doppler frequency estimate, Fd, with the center frequency at peak output, Fm. Otherwise, an update process 214 updates the center frequency values for the energy detectors 202, 204 and 206 and adjusts the bandwidth values, BW1, BW2 and BW3, or for the example of FIG. 2, the value, BW, the common bandwidth for each of the energy detectors.

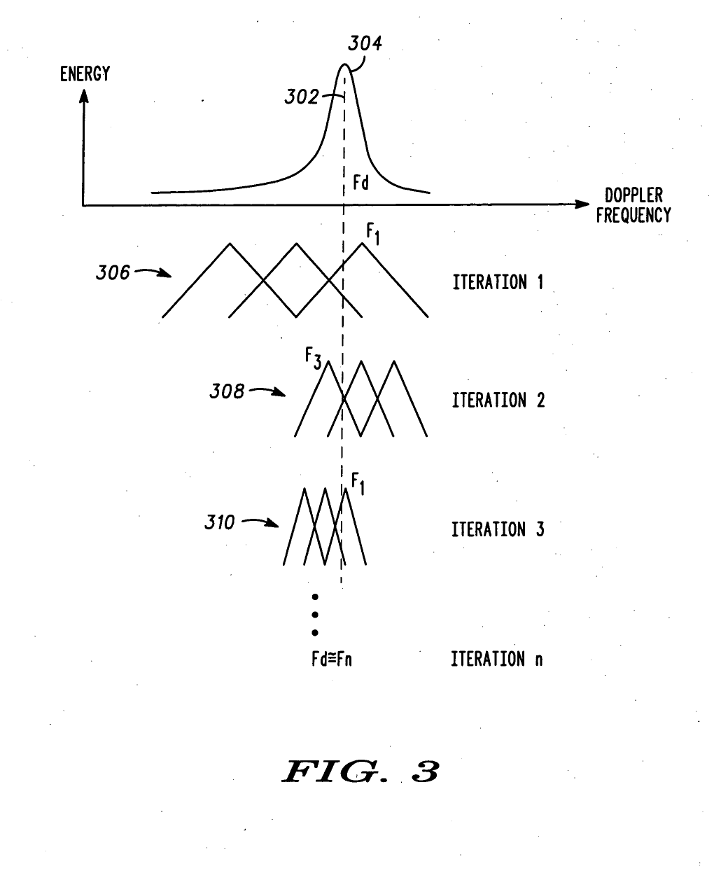

FIG. 3 illustrates a frequency estimation process that may be implemented by the frequency detector 124. The sought after Doppler frequency, Fd, is depicted as the phantom line 302 with an energy distribution 304. The energy detectors 202, 204 and 206 are initialized such that the center frequencies F1, F2 and F3 are set relative to a base center frequency F0. The base center frequency F0 may be selected based upon an anticipated value of the Doppler frequency. The center frequencies F1, F2 and F3 are defined based upon the base center frequency F0, and may be chosen to be uniformly or non-uniformly distributed within the energy distribution 304. In the example of FIG. 3, F1 is set below the base center frequency, F2 is set at the base center frequency and F3 is set above the base center frequency with uniform spacing. Each energy detector 202, 204 and 206 also is assigned a bandwidth value, BW1, BW2 and BW3, respectively, but carrying over the example described in FIG. 2 and here in FIG. 3, the bandwidth values for each of the energy detectors is the same and is depicted as bandwidth BW. The total bandwidth of each of the energy detectors initially should substantially correspond to but may be larger or smaller than the energy distribution 304 and defines a search band. Also, the size of the bandwidth and the spacing of the center frequencies may be such to ensure overlap of the bandwidth segments associated with each of the center frequencies. The common bandwidth. BW used for each energy detector of the example shown in FIGS. 2 and 3 allows the energy detectors 202, 204 and 206 to be initialized as follows:
F1=F0−0.5BW,BW
F2=F0, BW
F3=F0+0.5BW, BW. (1)

This initial configuration results in the search pattern 306 for the first iteration, FIG. 3. As the bandwidth associated with center frequency F1, and hence energy detector 202, sees a larger portion of the energy distribution 304, the energy detector 202 reports the peak energy value, Em=E1. Therefore, the center, frequency of the peak detector 208 will set Fm, i.e., Fm=F1 and BWm, i.e., BWm=BW1=BW. Because, at least for the first iteration, BWm is not be less than the desired bandwidth, i.e., the desired level of resolution is not achieved on the first iteration, the update process 214 is invoked causing F0 to be set equal to Fm=F1 and energy detector bandswidths BW1, BW2 and BW3 to be adjusted, e.g., set at half the current bandwidth, BW1=BW2=BW3=BW=0.5 BWm. Of course the bandwidth may be adjusted in different increments and need not be uniformly adjusted; however, it must be reduced to provide convergence to the search. The energy detectors are then reinitialized based upon equations 1, above, resulting in the search pattern 308 for the second iteration.

For the second iteration it can be seen that the center frequency F3, and hence energy detector 206, sees a larger portion of the energy distribution 304 the energy detector 206 reports the peak energy value, Em=E3. The values of Fm and BWm are then set. If the desired resolution still is not achieved, the update process 214 is invoked and the energy detectors 202, 204 and 206 are reinitialized resulting in the search pattern 310. The process continues for several iterations until the desired level of resolution is achieved. At that point, Fm=Fn, where n is the number of iterations, and Fd is set equal to Fn.

Referring to FIG. 4, a device 400 is similar in construction to the device 100, and like reference numerals are used to indicate like elements. The device 400 differs from the device 100 in that code wipe off/despreader 114 is positioned before frequency correction circuit 108. The frequency detector 124 are positioned to receive the despread signal output 402 of the despreader 114 and the estimated Doppler frequency, Fd, is input directly to the NCO 112 for affecting frequency correction at the frequency correction circuit 108 prior to integration 120 and processing 122.

This disclosure is provided to explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, discussion of such software and ICs, if any, is limited to the essentials with respect to the principles and concepts of the preferred embodiments.

We claim:

1. A method of iteratively estimating the frequency of a received signal comprising the steps of:
determining a search band;
determining an energy associated with a plurality of frequencies within the search band to provide a determined energy for each of the plurality of frequencies;
determining the one of the plurality of frequencies having a maximum determined energy; and
iteratively estimating the Doppler frequency as the determined one of the plurality of frequencies after an iteration criteria is achieved.

2. The method of claim 1, comprising for each iteration:
redefining the search band based upon the determined one of the plurality of frequencies to provide a redefined search band; and
estimating the Doppler frequency based upon the redefined search band.

3. The method of claim 2, wherein the step of redefining the search band comprises:
determining an adjusted search band different than the search band; and
centering the adjusted search band on the one of the plurality of frequencies.

4. The method of claim 3, wherein the step of determining an adjusted search bandwidth comprises halving the search bandwidth.

5. The method of claim 1, wherein the step of determining a search band comprises the steps of:
determining a center frequency, and
centering the search band on the center frequency.

6. The method of claim 1, wherein the step of determining a search band comprises the step of:
determining a center frequency;
determining a lower frequency based upon the search band and the center frequency; and
determining an upper frequency based upon the search band and the center frequency.

7. The method of claim 6, wherein the plurality of frequencies comprise the center frequency; the lower frequency and the upper frequency.

8. The method of claim 6, wherein the center frequency, lower frequency and upper frequency are selected to provide overlapping portions in the search band.

9. The method of claim 1, wherein the step of determining a search band comprises:
establishing a plurality of bandwidths, one each of the plurality of bandwidths corresponding to a frequency of the plurality of frequencies, and determining the search band based upon plurality of bandwidths.

10. The methods of claim 1, wherein a portion of a first of the plurality of bandwidths and a portion of a second of the plurality of bandwidths overlap.

11. A method of iteratively estimating a Doppler frequency or carrier frequency comprising the steps of:
initializing a plurality of energy detectors, each energy detector having a common bandwidth and a center frequency, the center frequency being one of a base center frequency, a lower center frequency less than the base center frequency and an upper center frequency greater than the base center frequency;
determining an energy concentration associated with each of the plurality of energy detectors to identify one center frequency having a peak energy; and
iteratively estimating the Doppler frequency as the determined one center frequency having the peak energy after an iteration criteria is achieved.

12. The method of claim 11, comprising for each iteration:
adjusting the common bandwidth to provide an adjusted common bandwidth and setting the base center frequency to be the determined one center frequency having the peak energy to provide an adjusted center frequency; and
estimating the Doppler frequency based upon the adjusted common bandwidth and the adjusted center frequency.

13. The method of claim 12, wherein adjusting the common bandwidth comprises halving the common bandwidth.

14. An iterative frequency detection module comprising:
a plurality of energy detectors, wherein each energy detector is operable to determine an energy concentration for an associated center frequency and bandwidth, the center frequency being selected relative to a base center frequency; and
a controller coupled to each of the plurality of energy detectors, the controller operable to determine an energy detector of the plurality of energy detectors reporting peak energy value and to iteratively adjust the bandwidth and center frequency associated with each of the plurality of energy detectors such that for each iteration the subsequent adjusted bandwidth is less than the bandwidth and the subsequent base center frequency set to the center frequency of the energy detector having the peak energy value.

15. The apparatus of claim 14, wherein each energy detector comprises a filter with adaptive coefficients operatively coupled to a rectifier.

16. The apparatus of claim 14, wherein each energy detector comprises one of a quadratic detector and a linear summation of lag-weighted instantaneous autocorrelation with adaptive coefficients.

17. The frequency detection module of claim 14, wherein the controller is operable to reduce the bandwidth with each iteration.

18. The frequency detection module of claim 14, wherein the controller is operable to halve the bandwidth with each iteration.

19. The frequency detection-module of claim 14, comprising the base center frequency is associated with a first of the plurality of energy detectors; a lower center frequency, lower than the base center frequency, is associated with a second of the plurality of energy detectors and an upper center frequency, greater than the base center frequency, is associated with a third of the plurality of energy detectors.

20. The frequency detection module of claim 19, wherein the lower center frequency has a frequency value lower by one half the bandwidth than the base center frequency and the upper center frequency is greater by one half the bandwidth than the base center frequency.

21. The frequency detection module of claim 14, wherein the controller is operable to estimate a Doppler frequency based upon the center frequency of the energy detector reporting a peak energy value after a predetermined number of iterations.

22. A personal communication device comprising:
a transceiver operable to transmit and receive wirelessly communicated data; and
a frequency detection module coupled to the transceiver, the frequency detection module including:
a plurality of energy detectors, wherein each energy detector is operable to determine an energy concentration for an associated center frequency and bandwidth, the center frequency being selected relative to a base center frequency; and
a controller coupled to each of the plurality of energy detectors, the controller operable to determine an energy detector of the plurality of energy detectors reporting a peak energy value and to iteratively adjust the bandwidth and center frequency associated with each of the plurality of energy detectors such that for each iteration the subsequent adjusted bandwidth is less than the bandwidth and the subsequent base center frequency is set to the center frequency of the energy detector reporting the peak energy value.

23. The personal communication device of claim 22, wherein the personal communication device comprises one of the group of personal communication devices comprising: a cellular telephone, a pager, a personal digital assistant, a WiFi enabled computer and a navigation tool.

24. An apparatus for estimating a Doppler or carrier frequency comprising:
for a base center frequency, a lower center frequency less than base the center frequency and an upper center frequency greater than the base center frequency, each of the base center frequency, lower center frequency and upper center frequency having a common bandwidth associated therewith, means for determining a center frequency from one of the base center frequency, lower center frequency and upper center frequency having a peak energy measurement;
means for adjusting the common bandwidth;
means for shifting the base center frequency to correspond to the center frequency of having the peak energy measurement; and
means for estimating the Doppler frequency as a last determined one center frequency having a peak energy measurement from a predetermined number of iterations.

25. The apparatus of claim 24, where in the means for shifting the base center frequency comprises means for modulating the base low-pass detector to convert it into a band-pass detector.

26. The apparatus of claim 25, wherein the means for modulating the base low-pass detector comprises a Coordinate Rotation Digital Computer (CORDIC) algorithm.
